(19) United States
(12) Patent Application Publication
(10) Pub. No.: US 2010/0040969 A1
(43) Pub. Date: Feb. 18, 2010

(54) Toner Formulations with Tribocharge Control and Stability

(76) Inventors: Ligia Aura Bejat, Versailles, KY (US); Joseph Edward Johnson, Lexington, KY (US); Rick Owen Jones, Berthoud, CO (US); Bryan Patrick Livengood, Nicholasville, KY (US); Kasturi Rangan Srinivasan, Longmont, CO (US); Devon Jean Vaccaro Strain, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/190,318

(22) Filed: Aug. 12, 2008

(51) Int. Cl. G03G 9/113

(52) U.S. Cl. 430/111.1

(57) ABSTRACT

A toner composition and a method of making a toner composition wherein toner particles having an average size in the range of 1-25 μm may be mixed with silica particles and alumina particles surface treated with an inorganic/organic compound. The silica particles may have a primary particle size in the range of 2 nm to 20 nm and may be present in the range of 0.01% to 3.0% by weight of the toner composition. The alumina particles surface treated with an inorganic/organic compound may be present in the range of 0.01% to 1.0% by weight of the toner composition.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to a method of improving charge and charge stability of a toner composition using alumina and silica.

2. Description of the Related Art

Toner may be utilized in image forming devices, such as printers, copiers and/or fax machines to form images upon a sheet of media. The image forming apparatus may transfer the toner from a reservoir to the media via a developer system utilizing differential charges generated between the toner particles and the various components in the developer system. Control of toner tribocharge and flow properties may be achieved by dry toner surface modification and the attachment or placement of fine particles, or extra-particulate additives on the surface of the particles.

### SUMMARY OF THE INVENTION

An aspect of the present disclosure relates to a toner composition and a method of making a toner composition which may used in an electrophotographic printer or printer cartridge. The toner composition comprises toner particles having an average size in the range of 1-25 μm that may be mixed with fumed hydrophobic silica and alumina particles which have been surface treated with inorganic/organic compound(s). The silica particles may have an average primary particle size in the range of 2 nm to 20 nm and may be present in the range of 0.01% to 3.0% by weight of the toner composition. The hydrophobic alumina particles may be present in the range of 0.01% to 1.0% by weight of the toner composition. The toner particles, prior to the presence of the silica particles and alumina particles may define a base toner having a charge per unit area

T_{BASE}(μC/cm²)

and the toner particles containing the silica particles and the alumina particles may define toner including additive having a charge per unit area

T_{ADDITIVE}(μC/cm²)

wherein

T_{ADDITIVE}(μC/cm²)=(0.700−0.985) T_{BASE}(μC/cm²).

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present disclosure is directed at a composition and method for improving the charge control and charge stability of a toner composition by providing extra particular agents including alumina (Al₂O₃) and relatively small silica (SiO₂) to the toner, and in particular, to the toner particle surface. The toner particles may be prepared by a chemical process, such as suspension polymerization or emulsion aggregation. In one example, the toner particles may be prepared via an emulsion aggregation procedure, which generally provides resin, colorant and other additives. More specifically, the toner particles may be prepared via the steps of initially preparing a polymer latex from vinyl type monomers, such as acrylate based monomers or styrene-acrylate base copolymers, in the presence of an ionic type surfactant. The polymer latex so formed may be prepared at a desired molecular weight distribution (MWD=Mw/Mn) and may, for example, contain both relatively low and relatively high molecular weight fractions to thereby provide a relatively bimodal distribution of molecular weights. Pigments may then be milled in water along with a surfactant that has the same ionic charge as that employed for the polymer latex. Release agent (e.g., a wax or mixture of waxes) including olefin type waxes such as polyethylene may also be prepared in the presence of a surfactant that assumes the same ionic charge as the surfactant employed in the polymer latex. Optionally, one may include a charge control agent.

The polymer latex, pigment latex and wax latex may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size.

Such mixture may then be heated to cause a drop in viscosity and the gel may collapse and relative loose (larger) aggregates, from about 1-25 μm, may be formed, including all values and ranges therein. For example, the aggregates may have a particle size between 3 μm to about 15 μm, or between about 4 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles. Coalescence is referenced to fusion of all components. The toner may then be removed from the solution, washed and dried.

It is also contemplated herein that the toner particles may be prepared by a number of other methods including mechanical methods, where a binder resin is provided, melted and combined with a wax, colorant and other optional additives. The product may then be solidified, ground and screened to provide toner particles of a given size or size range.

The resulting toner may have an average particle size in the range of 1 μm to 25 μm. The toner may then be treated with a blend of extra particulate agents, including hydrophobic fumed alumina, hydrophobic fumed small and/or large silica, and titania. Treatment using the extra particulate agents may occur in one or more steps, wherein the given agents may be added in one or more steps.

The alumina (Al₂O₃) that may be used herein may have an average primary particle size in the range of 5 nm to 100 nm, including between 7 nm to 50 nm (largest cross-sectional linear dimension) or between 7 nm to 25 nm. In addition, the alumina may be surface treated with an inorganic/organic compound which may then improve mixing (e.g., compatibility) with organic based toner compositions. For example, the alumina may include a silane coating or other coatings, such as chloro(dimethyl)octylsilane, dimethoxy(methyl)octylsilane, or methoxy(dimethyl)octylsilane.

The alumina may be present in the range of 0.01% to 1.0% by weight of the toner composition, including in the range of 0.10% to 0.50% by weight. The presence of alumina, in amounts of 0.1% to 1.0% by weight, was observed to reduce the triboelectric charge that the toner may assume when utilized in an electrophotographic printer along with the ability to achieve a desired print density. In such regard, it may be appreciated that high relative charge makes it relatively difficult to achieve a target print density.

Accordingly, the reduction in triboelectric charge (see below) may be at least 5% at relatively low temperature and low humidity conditions, (e.g., 60° F./8% RH) over a base toner without alumina, including otherwise comparable additive packages. At relatively high temperature and high humidity conditions, (e.g., 78° F./80% RH) the alumina may reduce the charge assumed by the toner by at least 1.5%. Overall, the toner charge may be reduced by 1.5% to 30% with the addition of alumina extra particulate agent as compared to toner that does not contain such additive. An example of the aluminum oxide may be that available from Evonik Degussa under the tradename AEROXIDE and product number C 805; from Sukgyung A-T, Inc. under the product number SG-A030; from Cabot Corp. under the product number TG-A90; and from Sumitomo Chemical under the product number AKP-G008 and AKP-G015.

It may be appreciated that for a given amount of toner for a selected area (i.e. m/a or mg/cm²) the toner may be charged to a level measured as microcoulombs/gram (μC/g). Accordingly, one may determine a value of charge per unit area by multiplying the value of (m/a)*(μC/g) to generate the toner charge in μC/cm². Accordingly, in units of μC/cm² base toner without the additives herein (T_{BASE}) was found to have a relatively higher charge with a given printer environment than toner including the additives (T_{ADDITIVES}) herein (i.e., alumina and/or silica). In other words, the value of charge per unit area for T_{ADDITIVES} is 0.985 or less than the charge per unit area for T_{BASE}. For example, the charge per unit area for toner containing the additives (T_{ADDITIVES}) herein may be 0.700−0.985 of the charge per unit area of the base toner (T_{BASE}).

Referring again to the extra-particulate agents that may be used herein, relatively small silica may be understood as silica (SiO₂) having an average primary particle size in the range of 2 nm to 20 nm, or between 5 nm to 15 nm (largest cross-sectional linear dimension) prior to any after treatment. The relatively small silica may be present in the toner formulation as an extra particulate agent in the range of 0.01% to 3.0% by weight of the toner composition, such as 0.1% to 1.0% by weight. Relatively large silica may be understood as silica having an average primary particle size in the range of 20 nm to 200 nm, or between 30 nm to 75 nm, prior to any after treatment. The relatively large silica may be present in the toner formulation as an extra particulate additive in the range of 0.1% to 5.0% by weight of the toner composition, such as 0.25-3.0% by weight of the toner composition.

The silicas may also be treated with surface additives that may impart different hydrophobic characteristics or different charges to the silica. For example, the silica may be treated with hexamethyldisilazane, polydimethylsiloxane, dimethyldichlorosilane, octylsilane, etc. Exemplary silicas may be available from Evonik Degussa under the tradename AEROSIL and product numbers R812, RX50 or RY50. Other contemplated silicas may include those available from Ineos Silicas of Joliet, Ill. or Cabot Corp. of MA under the tradename CAB-O-SIL.

In addition, titania (titanium-oxygen compounds such as titanium dioxide) may be added to the toner composition as a extra particulate additive. The titania may be present in the formulation in the range of about 0.01% to 3.0% by weight by weight of the toner formulation, such as 0.1% to 1.0%. The titania may include a surface treatment, such as aluminum oxide. The titania particles may have a mean particle length in the range of 0.1 μm to 3.0 μm, such as 0.5-2.0 μm and a mean particle diameter in the range of 0.01 μm to 0.2 μm, such as 0.13 μm. An example of titania contemplated herein may include FTL-110 available from ISK USA. Other contemplated titanias may include those available from DuPont; Kemira of Finland under the product designation Kemira RODI or RDI-S; or Huntsman Pigments of Texas under the product name TIOXIDE R-XL.

### EXAMPLES

The examples herein are for the purposes of illustration and are not intended to be exhaustive or to limit the invention to the formulations discussed herein.

### Example 1

A base toner composition was formulated that included styrene-acrylate based copolymer having a Mn of about 8,000, a Mw of about 15,000 and a Tg of about 51° C. Various pigments were utilized, however in one example, a magenta pigment including approximately 5.1% by weight of pigment PR122 and 1.7% by weight pigment PR185 were added. A release agent including about 4.8% by weight polyethylene wax and approximately 3.75% by weight of charge control agents were added as well.

### Example 2

The above base toner composition was treated with a blend of a silica (AEROSIL R812 available from Evonik Degussa Chemical) and 0.2% of a metal oxide as illustrated in Table 1, below, wherein the metal oxides included aluminum oxide (AEROXIDE C, non-surface treated, available from Evonik Degussa Chemical), zinc oxide (SNUG30 available from Sukgyung A.T. Co., Ltd.), titania (SG-TO30C, available from Sukgyung A-T) and silica (TG1827 available from Cabot). This was followed by further blending 2% silica (AEROSIL RX50 available from Evonik Degussa Chemical) and titania surface treated with aluminum oxide (FTL-110 available from ISK USA).

The toner formulations were evaluated after 1 hour of testing time in a bench cartridge robot. A number of measurements were made, including charge measurements, toner mass and cohesion. Charge measurements (Q/M) were made as described above. In addition, charge over a given area (Q/A) was measured as well. Toner mass (Mass) was measured using a vacuum pencil and removing toner from the surface of a developer roll. The results of these tests are also provided in Table 1.

TABLE 1

| | Small | | Mass (m/a) | Charge | |
|---|---|---|---|---|---|
| | Silica | | (initial/final) | (initial/final) | Q/A (initial/final) |
| Toner ID | (R812) | Metal Oxide | (mg/cm²) | Q/M(μC/g) | (μC/cm²) |
| Comparative | 0.5% | 0% | 0.47/0.51 | −52/−43 | −24/−22 |
| Example 1 | | | | | |
| Comparative | 0.2% | 0% | 0.47/0.71 | −41/−35 | −19/−25 |
| Example 2 | | | | | |
| Example 1 | 0.2% | 0.2% Aluminum | 0.38/0.61 | −37/−29 | −14/−17 |
| | | Oxide | | | |
| Example 2 | 0.2% | 0.2% Zinc Oxide | 0.39/0.49 | −53/−43 | −14/−17 |
| Example 3 | 0.2% | 0.2% Titania | 0.43/0.66 | −53/−35 | −14/−17 |
| Example 4 | 0.2% | 0.1% Silica | 0.46/0.68 | −51/−40 | −20/−23 |

As can be seen from the above, the formulation including aluminum oxide provided the lowest charge for a given mass of toner (Q/M).

### Example 3

Toner was prepared as described above, wherein the toner composition included styrene-acrylate based copolymer having a Mn of about 8,000, a Mw of about 15,000 and a Tg of about 51° C. Various pigments were utilized, however in one example, a magenta pigment including approximately 5.1% by weight of pigment PR122 and 1.7% by weight pigment PR185 were added. A release agent including about 4.8% by weight polyethylene wax and approximately 3.75% by weight of a charge control agent were added as well.

The toner composition was treated with a blend of relatively small silica (AEROSIL R812 available from Evonik Degussa Chemical), aluminum oxide (Alu O) (AEROXIDE C, non-surface treated, available from Evonik Degussa Chemical), relatively large silica (AEROSIL RX50 available from Evonik Degussa Chemical) and titania surface treated with aluminum oxide (FTL-110 available from ISK USA). The additives were added in multiple steps as illustrated in Table 2. Those additives blended during the pre-blend stage were combined first with the toner and then the remainder of the additives was combined in an additional blending step.

TABLE 2

| | Small Silica | Alu O | Large | | |
|---|---|---|---|---|---|
| | (R812) pre- | (C805) pre- | Silica | Titania | Alu O |
| Toner ID | blend | blend | (RX50) | (FTL-110) | (C805) |
| Comparative | 0.2% | 0% | 2% | 0.5% | 0% |
| Example 3 | | | | | |
| Example 3a | 0.2% | 0% | 2% | 0.5% | 0.5% |
| Example 3b | 0.2% | 0.5% | 2% | 0.5% | 0% |
| Example 3c | 0.2% | 0.5% | 25 | 0.5% | 0.5% |

The above toner formulations were tested for Epping Charge, cohesion, charge at relatively low humidity and relatively low temperature, charge at relatively high humidity (e.g., 80% relative humidity) and relatively high temperature (e.g., 78° F.), designated hot/humid or HH, the mass of toner on the developer roll (DR), charge over a given area (Q/A), toner usage at relatively low humidity (e.g., 8% relative humidity) and relatively low temperature (e.g., 60° F.), designated as low humidity and low temperature or LL, toner usage (TTU) at relatively high humidity and relatively high temperature, and toner to cleaner (TTC) (that is the toner removed from the photoconductor after imaging). In some test modes, printers were run on a 2 pages and pause cycle for 3000 pages, at both LL and HH conditions.

Cohesion may be understood as the powder flow of a toner, wherein lower cohesion provides relatively good flow behavior. Cohesion may be determined by placing a quantity of toner in a Hosakowa Micron powder flow tester. The device may include a nested stack of screens resting on a stage for a period of time, the amount of toner passing through the screens in the given time period is measured to calculate a cohesion value.

The results of the above tests are listed in Tables 3a and 3b.

TABLE 3a

| | Epping | | Charge | Mass on DR |
|---|---|---|---|---|
| Toner ID | Charge | Cohesion | (LL/HH) | (LL/HH) |
| Comparative Example 3 | −35 | 4.8 | −61/−68 | 0.52/0.50 |
| Example 3a | −18 | 3.0 | −48/−57 | 0.48/0.51 |
| Example 3b | −18 | 4.8 | −45/−51 | 0.47/0.54 |
| Example 3c | −12 | 4.0 | −36/−46 | 0.40/0.48 |

TABLE 3b

| | Q/A | Toner Usage | Toner to Cleaner |
|---|---|---|---|
| Toner ID | (LL/HH) | (LL/HH) | (LL/HH) |
| Comparative Example 3 | −32/−34 | 8.6/11.6 | 2.0/3.0 |
| Example 3a | −23/−29 | 12.4/18.9 | 5.5/10.2 |
| Example 3b | −21/−30 | 10.5/16.8 | 3.5/7.6 |
| Example 3c | −14/−22 | 17.4/23.1 | 9.7/13.8 |

As can be seen from the above, the addition of the alumina, regardless of when the addition occurred, provided for a decrease in toner charge. Furthermore, with the addition of more alumina, a lower charge was observed. In addition, as the charge was lowered and more alumina added, the mass on the developer roller appeared to decrease. However, as more alumina was added, the toner to cleaner value appeared to increase meaning that more waste toner was generated.

### Example 4

Blends of relatively small silica and relatively large silica were examined 10 utilizing two different types of large silica, wherein the primary silica particles are relatively similar. One type of relatively large silica was surface treated with hexamethyldisilazane (HMDS) (available from Evonik Degussa Chemicals as AEROSIL RX50). The other type of relatively large silica was surface treated with a silicone oil, polydimethylsiloxane (PDMS) (available from Evonik Degussa Chemicals as AEROSIL RY50).

The toner composition was prepared as described above in Example 1. In addition, all toners were blended with 0.2% by weight of relatively small silica (AREOSIL R812) and 0.5% by weight of titania (FTL-110). The toner was evaluated in terms of Cohesion, Epping Charge, charge at relatively low humidity and relatively low temperature, charge at relatively high humidity and high temperature, mass on the developer roller (DR), TTU, TTC, L* (which may be understood as a measurement of brightness, wherein L* of 100 is white and L* of 0 is black), and Mottle. Results of the tests are illustrated in Tables 4a and 4b.

TABLE 4a

| | | | | Epping | Charge |
|---|---|---|---|---|---|
| Toner ID | Alumina | Large Silica | Cohesion | Charge | (LL/HH) |
| Comparative | 0% | HMDS | 2.4 | −40 | −62/−57 |
| Example 4 | | | | | |
| Example 4a | 0.20% | HMDS | 1.1 | −18 | −50/−56 |
| Example 4b | 0.35% | HMDS | 2.4 | −5 | −45/−48 |
| Example 4c | 0.50% | HMDS | 0.8 | 6 | −43/−49 |
| Comparative | 0% | PDMS | | | −52/−55 |
| Example 5 | | | | | |
| Example 5a | 0.20% | PDMS | | | −44/−41 |
| Example 5b | 0.35% | PDMS | | | −38/−39 |
| Example 5c | 0.50% | PDMS | | | −43/−40 |

TABLE 4b

| | Mass on DR | TTU | TTC | L* | |
|---|---|---|---|---|---|
| Toner ID | (LL/HH) | (LL/HH) | (LL/HH) | (LL/HH) | Mottle |
| Comparative Example 4 | 0.45/0.51 | 7.4/9.8 | 0.7/1.7 | 19.9/10.1 | Severe |
| Example 4a | 0.45/0.49 | 8.2/12.6 | 0.8/3.9 | 17.9/9.4 | Light |
| Example 4b | 0.50/0.58 | 9.1/14.0 | 1.5/4.6 | 15.2/9.9 | No |
| Example 4c | 0.43/0.55 | 11.2/16.3 | 2.6/6.3 | 13.8/9.5 | No |
| Comparative Example 5 | 0.46/0.51 | 7.5/10.2 | 0.5/0.7 | 19.4/7.6 | Moderate |
| Example 5a | 0.49/0.61 | 7.9/10.8 | 0.9/1.9 | 14.8/10.1 | Slight |
| Example 5b | 0.42/0.53 | 10.0/17.5 | 2.2/8.2 | 15.5/12 | No |
| Example 5c | 0.42/0.51 | 8.3/15.2 | 0.8/5.6 | 15.4/13.1 | No |

As can be seen from the above, the addition of alumina reduced the toner charge. Furthermore, it appears that generally, the addition of the PDMS treated relatively large silica (RY-50) also resulted in a reduced charge. The addition of the alumina also appears to make the print density darker and reduce the effects of mottle. However, as alumina levels are increased, TTU is increased as well.

### Example 5

Using the above toner formulation, described in Example 1, various relatively small silicas were examined, wherein the silicas included different surface treatments, including hexamethyldisilazane (HMDS) (AEROSIL R812, AEROSIL R812S, AEROSIL RX200 all available from Evonik Degussa Chemical), polydimethylsiloxane (PDMS) (AEROSIL RY200, available from Evonik Degussa Chemical), dimethylchlorosilane (DMCS) (AEROSIL R972, available from Evonik Degussa Chemical) and octylsilane (OS) (AEROSIL R805, available from Evonik Degussa Chemical). The toner was prepared as described above, except it included black pigments rather than magenta and the toner was treated with 0.1% alumina (AEROXIDE C 805) blended with 2% relatively large silica (RX-50) and 0.5% titania (FTL-110). The additions of the relatively small silica is demonstrated in Table 5a, 5b, and 5c below along with the various test results for cohesion, charge (Q/M), charge (M/A), toner usage, ghosting and FTC.

TABLE 5a

| Toner ID | Alumina | Surface Treatment | Cohesion | Q/M (μC/g) | M/A (avg.) |
|---|---|---|---|---|---|
| Example 24 | 0.35% | HMDS (R812) | 9.4 | −70/−73 | 0.47/0.51 |
| Example 25 | 0.5% | HMDS (R812) | 11.5 | −76/−75 | 0.49/0.46 |
| Example 26 | 0.35% | HMDS (R812S) | 8.9 | −67/−72 | 0.50/0.49 |
| Example 27 | 0.5% | HMDS (R812S) | 7.1 | −79/−79 | 0.42/0.47 |
| Example 28 | 0.35% | HMDS (RX200) | 9.4 | −73/−63 | 0.51/0.51 |
| Example 29 | 0.5% | HMDS (RX200) | 11.5 | −74/−72 | 0.47/0.49 |
| Example 30 | 0.35% | PDMS (RY200) | 8.9 | −70/−66 | 0.47/0.52 |
| Example 31 | 0.5% | PDMS (RY200) | 7.1 | −73/−69 | 0.49/0.52 |
| Example 32 | 0.35% | DMCS (R972) | 9.4 | −64/−69 | 0.52/0.50 |
| Example 33 | 0.5% | DMCS (R972) | 11.5 | −75/−68 | 0.48/0.50 |
| Example 34 | 0.35% | OS (R805) | 8.9 | −73/−74 | 0.47/0.49 |
| Example 35 | 0.5% | OS (R805) | 7.1 | −64/−71 | 0.56/0.52 |

TABLE 5b

| Toner ID | Toner Usage | Ghosting (Ave.) | FTC (LL/HH) |
|---|---|---|---|
| Example 24 | 10.9/29.6 | 0.8/0.6 | −1.46/0.7 |
| Example 25 | 8.1/31.5 | 0.8/0.0 | −0.15/0.95 |
| Example 26 | 8.1/33.6 | 0.6/0.8 | 0.35/−0.42 |
| Example 27 | 7.5/27.7 | 1.2/0.4 | 0.16/−0.39 |
| Example 28 | 7.4/29.5 | 0.8/−0.3 | 0.21/−0.52 |
| Example 29 | 6.7/31.5 | 0.4/0.0 | −0.67/0.20 |
| Example 30 | 7.9/30.3 | 1.2/0.6 | −1.34/1.99 |
| Example 31 | 8.0/26.7 | 0.8/0.0 | 0.05/0.28 |
| Example 32 | 9.8/30.3 | 0.85/3.5 | −3.02/−1.14 |
| Example 33 | 7.5/36.6 | 0.7/0.7 | −0.08/−1.57 |
| Example 34 | 7.4/30.2 | 1.0/0.7 | −0.13/−0.08 |
| Example 35 | 10.4/26.8 | 0.7/0.7 | −0.61/0.63 |

TABLE 5c

| Toner ID | Q/M (μC/g) | M/A (avg.) | Toner Usage | FTC (LL/HH) |
|---|---|---|---|---|
| Example 24 | −43.1 | 0.34 | 14.1 | −0.39 |
| Example 25 | −44.6 | 0.35 | 13.8 | −1.47 |
| Example 26 | −46.5 | 0.34 | 10.3 | −0.33 |
| Example 27 | −43.9 | 0.35 | 12.4 | −1.80 |
| Example 28 | −45.7 | 0.34 | 10.3 | −1.12 |
| Example 29 | −44.6 | 0.34 | 11.2 | −1.54 |
| Example 30 | −44.6 | 0.35 | 13.1 | −1.15 |
| Example 31 | −46.6 | 0.33 | 11.6 | −0.93 |
| Example 32 | −50.4 | 0.33 | 10.3 | −2.77 |
| Example 33 | −46.2 | 0.37 | 10.1 | −0.36 |
| Example 34 | −45.1 | 0.37 | 11.4 | −0.86 |
| Example 35 | −44.7 | 0.37 | 13.0 | −1.26 |

### Example 6

A base toner corresponding to Example 1 was treated with a blend of a silica (Aerosil R812 available from Evonik Degussa chemical) and 0.2% an aluminum oxide as illustrated in Table 6a, below, wherein the aluminum oxides correspond to C805, available from Evonik Degussa Chemical, SG-A030, available from Sukgyung A-T, Inc., TG-A90 available from Cabot, AKP-G008 and AKP-G015 available from Sumitomo. This was followed by further blending with 2% silica (Aerosil RX-50 available from Evonik Degussa Chemical) and titania surface treated with aluminum oxide (FTL-110 available from ISK USA). Toners were evaluated in a printer at a run mode corresponding to a 2 page and pause print cycle at lab ambient conditions to 1000 pages. Results are summarized below in Table 6b.

TABLE 6a

| | | Surface Area |
|---|---|---|
| Alumina Type | Manufacturer | (m²/g) |
| C805 | Evonik Degussa | 100 |
| SG-ALO30 | Sukgyung A-T, Inc | 35 |
| TG-A90 | Cabot Corporation | 53 |
| AKP-G008 | Sumitomo Chemical | 80 |
| AKP-G015 | Sumitomo Chemical | 150 |

TABLE 6b

| | Alumina | Q/M | M/A | Q/A | Usage | |
|---|---|---|---|---|---|---|
| Toner ID | Type | (□C/g) | (mg/cm²) | (nC/cm²) | (mg/page) | PQ Defects |
| Comparative | N/A | −73.5 | 0.42 | −31.0 | 16.4 | Mottle |
| Example-1 | | | | | | |
| Example-1 | C805 | −67.2 | 0.40 | −26.8 | 17.7 | None |
| Example-1 | SG-ALO30 | −76.9 | 0.42 | −32.6 | 16.1 | None |
| Example-1 | TG-A90 | −71.0 | 0.42 | −29.6 | 16.9 | None |
| Example-1 | AKP-G008 | −70.6 | 0.42 | −29.8 | 18.1 | Slight |
| Example-1 | AKP-G015 | −58.8 | 0.42 | −24.6 | 23.4 | None |

As can be seen from the above table, the addition of the surface treated alumina tends to lower the charge of the toner, while the developer roll mass per unit area is unaffected. While most aluminas exhibited similar toner usage as the Comparative Example toner, AKP-G015 exhibited slightly higher usage. From a print quality standpoint, mottle is observed when there is relatively high average toner charge on the developer roll, causing non-uniform development of toner from the developer roll to the photoconductor drum and eventually to the image substrate, in this case, a paper. The defect manifests as multiple, random short dark streaks on the paper. This defect was observed for the comparative example toner and not for most aluminas. In the case of AKP-G008, there was a slight hint of non-high flow mottle. It is apparent from the above results that the use of an additive such as aluminum oxide can improve uniformity in toner development resulting in more uniform prints.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A toner composition comprising:
toner particles having an average size in the range of 1-25 μm;
silica particles disposed on said toner particles having a primary particle size in the range of 2 nm to 20 nm, wherein said silica particles are present in the range of 0.01% to 3% by weight of the toner composition; and
alumina particles surface treated with an inorganic/organic compound disposed on said toner particles, wherein said alumina particles are present in the range of 0.01% to 1.0% by weight of the toner composition
wherein said toner particles, prior to the presence of said silica particles and alumina particles defines a base toner having a charge per unit area
T_{BASE}(μC/cm²)
and said toner particles containing said silica particles and alumina particles defines toner including additive having a charge per unit area
T_{ADDITIVE}(μC/cm²)
wherein
T_{ADDITIVE}(μC/cm²)=(0.700−0.985)T_{BASE}(μC/cm²).

2. The toner composition of claim 1, wherein said alumina particles are present in said 2 toner composition in the range of 0.10% to 0.50% by weight.

3. The toner composition of claim 1, wherein at least a portion of said silica particles particles having a primary particle size in the range of 2 nm to 20 nm are surface treated with an agent selected from the group consisting of: hexamethyldisilazane, polydimethylsiloxane, dimethylchlorosilane, octylsilane and combinations thereof.

4. The toner composition of claim 1, further comprising silica particles having an average primary particle size in the range of 20 nm to 300 nm, present in said toner composition in the range of 0.1 to 5% by weight.

5. The toner composition of claim 4, wherein at least a portion of said silica particles having an average primary particle size in the range of 20 nm to 200 nm are surface treated with an agent selected from the group consisting of: hexamethyldisilazane, polydimethylsiloxane, dimethylchlorosilane, octylsilane and combinations thereof.

6. The toner composition of claim 1, wherein said inorganic/organic compound comprises a silane.

7. The toner composition of claim 1, wherein said alumina particles have an average primary particle size in the range of 5 to 100 nm.

8. The toner composition of claim 1, further comprising titania the range of 0.01% to 3.0% by weight of the toner composition.

9. The toner composition of claim 8, wherein said titania is surface treated with alumina.

10. The toner composition of claim 1, wherein said toner particles are styrene-acrylate based copolymers.

11. A method for controlling toner charge comprising:
mixing toner particles having an average size in the range of 1-25 μm, silica particles having a primary particle size in the range of 2 nm to 20 nm, wherein said silica particles are present in the range of 0.01% to 3.0% by weight of the toner composition, and alumina particles surface treated with an inorganic/organic compound, wherein said alumina particles are present in the range of 0.01% to 1.0% by weight of the toner composition
wherein said toner particles, prior to the presence of said silica particles and alumina particles defines a base toner having a charge per unit area
T_{BASE}(μC/cm²)
and said toner particles containing said silica particles and alumina particles defines toner including additive having a charge per unit area
T_{ADDITIVE}(C/cm²)
wherein
T_{ADDITIVE}(μC/cm²)=(0.700−0.985)T_{BASE}(μC/cm²).

12. The method of claim 11, wherein said alumina particles are present in the range of 0.1% to 0.5% by weight of the toner composition.

13. The method of claim 11, wherein at least a portion of said relatively small silica particles are surface treated with an agent selected from the group consisting of: hexamethyldisilazane, polydimethylsiloxane, dimethylchlorosilane, octylsilane and combinations thereof.

14. The method of claim 11, further comprising mixing relatively large silica particles having an average primary particle size in the range of 20 nm to 200 nm, present in said toner composition in the range of 0.1 to 5% by weight, with said toner particles.

15. The method of claim 14, wherein at least a portion of said relatively large silica particles are surface treated with an agent selected from the group consisting of: hexamethyldisilazane, polydimethylsiloxane, dimethylchlorosilane, octylsilane and combinations thereof.

16. The method of claim 11, wherein said inorganic/organic compound comprises a silane.

17. The method of claim 11, wherein said alumina particles have an average primary particle size in the range of 5 to 100 nm.

18. The method of claim 11, further comprising mixing titania the range of 0.01% to 3.0% by weight of the toner composition with said toner particles.

19. The method of claim 18, wherein said titania is surface treated with alumina.

20. The method of claim 11, wherein said toner particles are styrene-acrylate based copolymers.
